(19) United States
(12) Patent Application Publication
(10) Pub. No.: US 2014/0125127 A1
(43) Pub. Date: May 8, 2014

(54) BIAS CIRCUIT AND ELECTRONIC APPARATUS

(71) Applicant: WISTRON CORP., HSICHIH (TW)

(72) Inventors: YING-TZU CHOU, NEW TAIPEI CITY (TW); CHUN-TA LEE, NEW TAIPEI CITY (TW)

(73) Assignee: WISTRON CORP., NEW TAIPEI CITY (TW)

(21) Appl. No.: 13/834,391

(22) Filed: Mar. 15, 2013

(30) Foreign Application Priority Data
Nov. 6, 2012 (TW) 101141086

(51) Int. Cl. H02J 1/00

(52) U.S. Cl. CPC H02J 1/00
USPC 307/23

(57) ABSTRACT

A bias circuit is disclosed. The bias circuit includes a first boost circuit, a first control circuit and a first switch circuit. The first boost circuit receives a first control signal and determines whether to be enabled accordingly. The first control circuit transmits the first control signal according to a first input voltage detected. The first switch circuit determines an open or a closed state according to the first input voltage, wherein when the first input voltage is equal to a predetermined voltage value, the first switch circuit closes and the first boost circuit controlled by the first control signal is to be disabled, and then the first boost circuit converts the first input voltage to a first output voltage, wherein the first output voltage is smaller than the predetermined voltage value.

### BACKGROUND OF THE DISCLOSURE

1. Field of the Disclosure

The instant disclosure relates to a Tablet PC; in particular, to a bias circuit of a Tablet PC.

2. Description of Related Art

With continuous inventions and improvements in high technology, consumer electronic products are gradually becoming commonly used in daily lives of people, especially various types of electronic devices such as: cell phones, digital cameras, personal digital assistants (PDA), and Tablet PCs; the consumer electronic products are popular for their features of thinness, smallness, and portability. However, when using the portable electronic devices, there is a problem of the time durance of power supply; as for now, the common solution is to mix using Ni-MH batteries or Lithium batteries with extra respectively matched chargers.

Currently, in the process of power supply with a combination of a Tablet PC and a cradle, an input voltage (such as 5 or 12 volts) coupled to the Micro USB of the cradle is directly sent into the integrated circuit (IC) of the cradle, and then there is a voltage from the integrated circuit outputted and transferred to the boost circuit to boost the voltage (such as 5 volts); after being through a switch, the output voltage is finally supplied for the Tablet PC. Therefore, during the process of power supply, there is always a problem of ineffective power transition which leads to a power wastage.

### SUMMARY OF THE DISCLOSURE

The instant disclosure provides a bias circuit, the bias circuit includes a first boost circuit, a first control circuit, and a first switch circuit. The first boost circuit receives a first control signal and determines whether to be enabled according to the first control signal. The first control circuit is electrically connected to the first boost circuit, and the first control circuit transmits the first control signal according to a first input voltage detected. The first switch circuit is electrically connected between the first boost circuit and a charging battery, and the first switch circuit determines to be set as an open or closed status according to the first input voltage, wherein when the first input voltage is equal to a predetermined voltage value, the first switch circuit is closed and the first boost circuit controlled by the first control signal is disabled, and the first boost circuit converts the first input voltage into a first output voltage, wherein the first output voltage is smaller than the predetermined voltage value.

In an embodiment of the instant disclosure, when a first input voltage is close to a zero level voltage, the first switch circuit is open and the first boost circuit controlled by the first control signal is enabled, and the first boost circuit increases a second input voltage sent by the first switch circuit of the charging battery to be a first output voltage, where in the first output voltage is equal to the predetermined voltage value.

In an embodiment of the instant disclosure, the bias circuit further includes a charging management circuit. The charging management circuit is electrically connected with the first input voltage, the charging battery and the first boost circuit. The charging management circuit determines whether to output the first voltage to the charging battery according to a first input current. The charging management circuit includes a current detecting unit and a charging circuit. The current detecting unit is used to detect the first input current and accordingly to output a charging enable voltage. The charging circuit is electrically connected between the current detecting unit and the charging battery, and when the current detecting unit detects the first input current, the charging circuit transmits a first voltage to the charging battery to perform charging according to the charging enable voltage received.

In an embodiment of the instant disclosure, the bias circuit further includes a buck circuit and a single path circuit. The buck circuit receives a first original input voltage and reduces the first original input voltage to the predetermined voltage value as a second voltage. The single path circuit is electrically connected to the buck circuit, and the single path circuit receives a second original input voltage and the second voltage, and then outputs the first input voltage. In which, the voltage value of the first original input voltage is larger than the predetermined voltage value, and the voltage value of the second original input voltage is equal to the predetermined voltage value.

In an embodiment of the instant disclosure, the first switch circuit includes a first P-type transistor. A source and a gate of the P-type transistor are electrically connected to an input terminal of the first boost circuit, and a drain of the first P-type transistor is electrically connected to the charging battery, wherein when the first input voltage is equal to the predetermined voltage value, the first P-type transistor is switched off; when the first input voltage is close to the zero level voltage, the first P-type transistor is switched on.

In an embodiment of the instant disclosure, the current detecting unit includes a resistor. A first terminal of the resistor is electrically connected to the first input voltage, and a second terminal of the resistor is electrically connected to the input terminal of the first boost circuit, and the resistor is used to detect the first input current and to generate the charging enable voltage.

In the embodiment of the instant disclosure, the first boost circuit includes a first inductance, a first N-type transistor and a first diode. A first terminal of the first inductance is electrically connected to a source and a gate of the first P-type transistor. A drain of the first N-type transistor is electrically connected to a second terminal of the first inductance, and the gate of the first N-type transistor receives the first control signal, and the source of the first N-type transistor is electrically connected to a ground voltage. A anode of the first diode is electrically connected to the second terminal of the first inductance, and a cathode of the first diode outputs the first output voltage. When the first input voltage is equal to the predetermined voltage value, the first control circuit transmits the first control signal to the gate of the first N-type transistor to switch off the first N-type transistor, and the first output voltage is smaller than the predetermined voltage value; when the first input voltage is close to the zero level voltage, the first control circuit transmits the first control signal to the gate of the first N-type transistor to switch on the first N-type transistor.

The instant disclosure provides another bias circuit, and the bias circuit includes a first boost circuit, a first control circuit, a first switch circuit and a voltage compensation circuit. The voltage compensation circuit includes a second boost circuit, a second control circuit, and a second switch circuit. The second boost circuit is electrically connected to the first boost circuit, and the second boost circuit outputs a second output voltage. The second switch circuit is electrically connected to the second boost circuit in parallel. The second control circuit receives a first output voltage and accordingly transmits a second control signal and a third control signal to the corresponding second boost circuit and second switch circuit respectively. When the first output voltage is equal to the predetermined voltage value, the second switch circuit is open while the second boost circuit is disabled, and the second output voltage is equal to the first output voltage.

In an embodiment of the instant disclosure, when the first output voltage is smaller than the predetermined voltage value, the second switch circuit is closed and the second boost circuit is enabled, and the second boost circuit increases the first output voltage to the predetermined voltage value.

In an embodiment of the instant disclosure, the second switch circuit includes a first switch. A first terminal of the first switch receives the first output voltage, and a second terminal of the first switch outputs a second output voltage, and the first switch determines whether to be switched on according to a third control signal.

In an embodiment of the instant disclosure, the second boost circuit includes a second inductance, a second N-type transistor and a second diode. A drain of the second N-type transistor is electrically connected to a second terminal of the second inductance, and a gate of the second N-type transistor receives the second control signal, and the source of the second N-type transistor is electrically connected to a ground voltage. A anode of the second diode is electrically connected to the second terminal of the second inductance, and a cathode of the second diode outputs the second output voltage. When the first output voltage is equal to the predetermined voltage value, the second control circuit transmits the second control signal to the gate of the second N-type transistor to switch off the second N-type transistor; when the first output voltage is smaller than the predetermined voltage value, the second control circuit transmits the second control signal to the gate of the second N-type transistor to switch on the second N-type transistor, and the first output voltage is increased to the predetermined voltage value.

The instant disclosure further provides an electronic device, and the electronic device includes a bias circuit and a load. The bias circuit is used to output a first output voltage or a second output voltage, wherein the voltage value of the second output voltage is equal to a predetermined voltage value. The load receives the first output voltage or the second output voltage correspondingly.

To sum up, the present embodiments of the instant disclosure provide a bias circuit and an electronic device, wherein when the first input voltage is equal to the predetermined voltage value, the first boost circuit is disabled according to the first control signal, and the first boost circuit outputs the first output voltage, wherein the first output voltage is smaller than the predetermined voltage value. Based on the above, the first input voltage is able to be directly sent to the input terminal of the first boost circuit without passing the charging circuit and the charging battery, which decreases the wastage of the power and brings out the highest efficiency.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

FIG. 1 shows a circuit diagram of a bias circuit according to an embodiment of the instant disclosure;

FIG. 2 shows a circuit diagram of a bias circuit according to an alternate embodiment of the instant disclosure;

FIG. 3 shows a circuit diagram of a bias circuit according to another alternate embodiment of the instant disclosure;

FIG. 4 shows a detailed diagram of a bias circuit according to an embodiment of the instant disclosure;

FIG. 5 shows a schematic diagram of a electronic device according to an embodiment of the instant disclosure;

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

### Embodiment of a Bias Circuit

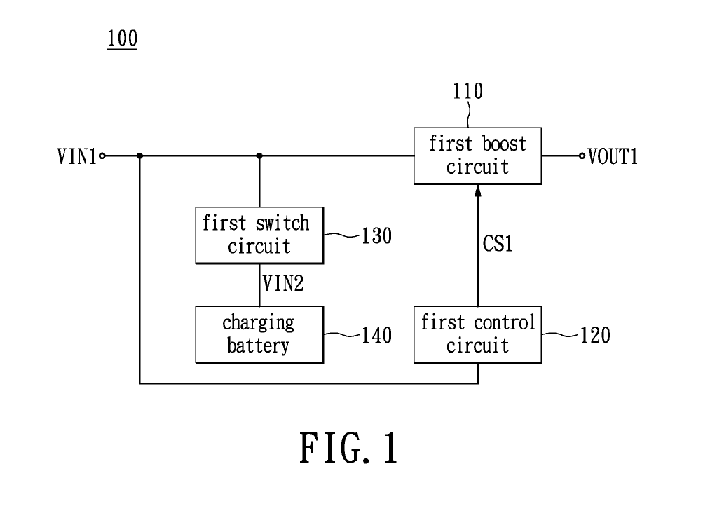

Referring to FIG. 1, FIG. 1 shows a circuit diagram of a bias circuit according to an embodiment of the instant disclosure. The bias circuit 100 includes a first boost circuit 110, a first control circuit 120, and a first switch circuit 130. The first boost circuit 110 is electrically connected to the first control circuit 120 and the first switch circuit 130. The first switch circuit 130 is electrically connected between a charging battery 140 and the first boost circuit 110.

The first boost circuit 110 receives a first control signal CS1 and determines whether to be enabled according to the first control signal CS1. Furthermore, the first control circuit 110 transmits the first control signal CS1 to the first control circuit 120 according to a first input voltage VIN detected. The first switch circuit 130 determines to be set as an open or closed status according to the first input voltage VIN; to be more specific, when the first input voltage VIN exists (in the embodiment of the instant disclosure, when the first input voltage VIN is equal to a predetermined voltage value), the first switch circuit 130 is closed and the first boost circuit 110 controlled by the first control signal CS1 is disabled, and the first boost circuit 110 converts the first input voltage VIN into a first output voltage VOUT1, wherein the first output voltage is smaller than the predetermined voltage value. In addition, when the first input voltage VIN is close to or equal to a zero level voltage, the first switch circuit 130 is open and the first boost circuit 110 controlled by the first signal CS1 increases a second input voltage VIN2 sent through the first switch circuit 130 by the charging battery to be the first output voltage VOUT1, which is actually equal to the predetermined voltage value.

The related operation of the bias circuit 100 is further described in the following paragraphs, for better understanding of the instant disclosure.

Referring to FIG. 1, when the input terminal of the bias circuit 100 is electrically connected to the first input voltage VIN which is equal to the predetermined voltage value (such as 5 volts), in the present embodiment, the first control circuit 120 detects the first input voltage VIN (equal to the predetermined voltage value) and transmits the first control signal CS1 to the first boost circuit 110 to disable the first boost circuit 110 according to the first voltage VIN. In the meantime, the first switch circuit 130 is closed because the first input voltage VIN is equal to the predetermined voltage value; therefore, the charging battery 140 is not able to output the second input voltage VIN2 to the input terminal of the first boost circuit 110. Moreover, the first boost circuit 110 converts the first input voltage VIN1 received into the first output voltage VOUT1. It is worth mentioning that since the first boost circuit 110 is in the disabled status, and the first boost circuit 130 is equipped with electronic elements inside, there is some part of power consumed on energy-consuming elements inside the first boost circuit 110.

On the other side, when the input terminal of the bias circuit 100 is not electrically connected to any power supply source and becoming floating, the first input voltage VIN is close to or equal to the zero level voltage. In the present embodiment, the first control circuit 120 transmits the first control signal CS1 to the first boost circuit 110 to enable the first boost circuit 110 according to an first input voltage VIN1 detected. In the meantime, since the first input voltage VIN is close to or equal to the zero level voltage and allows the first switch 130 to be open; therefore, the charging battery 140 sends a second input voltage VIN2 to the input terminal of the first boost circuit 110 through the route of the circuit 130, wherein the voltage value of the second input voltage VIN2 is smaller than the predetermined voltage value. Then, the first boost circuit 110 increases the second input voltage VIN2 received to be the output voltage VOUT1, which is actually equal to the predetermined voltage value at the time. In another embodiment, if the voltage value of the first output voltage VOUT1 is still smaller than the predetermined voltage value, the first output voltage VOUT1 is sent to a voltage compensation circuit (not illustrated in FIG. 1), for increasing the voltage value of the first output voltage VOUT1 to the predetermined voltage value as the load needs, and it is not limited thereto.

Based on the above, compared to the related art, when the voltage value of the first input voltage VIN is equal to the predetermined voltage value, the input voltage VIN is able to be directly sent to the input terminal of the first boost circuit 110 to reduces the wastage of power (only the wastage caused by the energy-consuming elements inside the first boost circuit) and achieves the highest efficiency.

To present more details in describing the operation process of the bias circuit 100 of the instant disclosure, there are further instructions in at least one of the following embodiments.

In the following embodiments, there are only the parts which are different from the embodiment in the FIG. 1 are described; in other words, the omitted parts are the same as described in the first embodiment. In addition, for the convenience during the instruction, similar numbers or codes refer to similar elements.

### Another Embodiment of a Bias Circuit

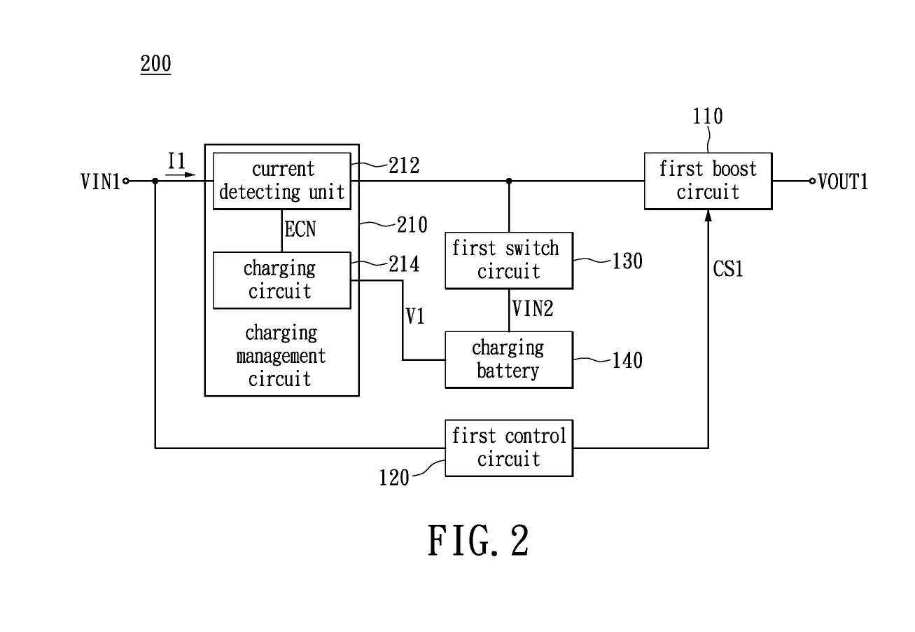

Referring to FIG. 2, FIG. 2 shows a circuit diagram of a bias circuit according to an alternate embodiment of the instant disclosure. Different from the embodiment of the FIG. 1, in the embodiment, a bias circuit 200 further includes a charging management circuit 210. The charging management circuit 210 includes a current detecting unit 212 and a charging circuit 214.

The charging management circuit 210 is electrically connected between a first input voltage VIN1 and a charging battery 140, and the charging management circuit 210 is electrically connected to the first boost circuit 110. The current detecting unit 212 is electrically connected between the first input voltage VIN1 and the first boost circuit 110. The charging circuit 214 is electrically connected to the current detecting unit 212.

In the present embodiment, the charging management circuit 210 is used to determine whether to output an first voltage V1 to an charging battery 140 to perform charging. The current detecting unit 212 is used to detect a first input current I1 and to output a charging enable voltage ECV according to the first input current I1, wherein the current detecting unit 212 may be a resistor in the present embodiment, but it is not limited thereto. The charging circuit 214 receives the charging enable voltage ECV sent by the current detecting unit 212 and the charging circuit 214 sends the first voltage V1 to the charging battery 140 to perform charging according to the charging enable voltage ECV.

There is further teaching in detailed operation about the bias circuit 200. Referring to FIG. 2, when the input terminal of the bias circuit 200 is electrically connected to the first input voltage VIN which is equal to the predetermined voltage value (such as 5 volts), a first control circuit 120 detects the first input voltage VIN (equal to the predetermined voltage value) and the first control circuit 120 transmits a first control signal CS1 to the first boost circuit 110 to disable the first boost circuit 110 according to the first voltage VIN. In the meantime, the current detecting unit 212 receives the first input current I1, and the current detecting unit 212 sends the charging enable voltage ECV to the charging circuit 214 according to the first input current I1 detected, and the charging circuit 214 sends the first voltage V1 corresponding to the first current I1 to the charging battery 140 to perform charging according to the charging enable voltage ECV received. In addition, a first switch circuit 130 is closed because the first input voltage VIN1 is equal to the predetermined voltage value (5 volts); furthermore, although the output terminal of the current detecting unit 212 consumes part of the power supplied by the first input voltage VIN1, the output terminal of the current detecting unit 212 outputs a voltage which is slightly smaller than the predetermined voltage value, in the present embodiment, the voltage is enough to close the first switch circuit 130. For the convenience in instruction, it is assumed that both the input and output terminals of the current detecting unit 212 are the first input voltage VIN1. Based on the assumption, the charging battery 140 is not able to output the second input voltage VIN2 to the input terminal of the first boost circuit 110.

Then, the first boost circuit 110 converts the first input voltage VIN1 received into the first output voltage VOUT1. Since the first boost circuit 110 is in the disabled status, and the first boost circuit 130 is equipped with electronic elements inside, there is some part of power consumed on energy-consuming elements inside the first boost circuit 110. In an embodiment, if the voltage value of the first output voltage VOUT1 is still smaller than the predetermined voltage value, then the first output voltage VOUT1 is sent to a voltage compensation circuit (not shown in FIG. 2) to increase the voltage value of the first output voltage VOUT1 to the predetermined voltage value as a load needs; however, it is not limited thereto.

Briefly, in the instant disclosure, when the bias circuit 200 receives the first input voltage VIN1 which is equal to the predetermined voltage value, the bias circuit 200 performs charging to the charging battery 140 via the charging management circuit 210, and the bias circuit 200 sacrifices part of the power from the first input voltage VIN1 and then sends the first input voltage VIN1 to the input terminal to generate the first output voltage VOUT1.

On the other side, when the input terminal of the bias circuit 200 is not electrically connected to any power supply source and becoming floating, in an exemplary embodiment, the first input voltage VIN is close to or equal to the zero level voltage. In the present embodiment, the first control circuit 120 detects the first input voltage VIN (not equal to the predetermined voltage value) and the first control circuit 120 transmits the first control signal CS1 to the first boost circuit 110 to enable the first boost circuit 110 according to the first input voltage VIN1. In the meantime, the current detecting unit 212 detects the first input current I1 (the voltage value of the first current I1 is zero at the time), the current detecting unit 212 transmits the charging enable voltage ECV corresponding to the first current I1 to the charging circuit 214, and the charging circuit 214 transmits the first voltage V1 to the charging battery 140 according to the charging enable voltage ECV received. Under the circumstances, the charging circuit 214 is not going to perform charging to the charging battery 140. Furthermore, the first switch circuit 130 is open because the first input voltage VIN1 is close to or equal to the zero level voltage (0 volts); therefore, the charging battery 140 then outputs an second input voltage VIN2 to the input terminal of the first boost circuit 110 via the first switch circuit 130.

Next, the first boost circuit 110 converts the second input voltage VINT2 received into the first output voltage VOUT1, wherein the voltage value of the second input voltage VIN2 is smaller than the predetermined voltage value. Since the first boost circuit 110 is in the enabled status, the first boost circuit 110 increases the second input voltage VIN2 to be equal to the predetermined voltage value and outputs the first output voltage VOUT1. In an embodiment, if the voltage value of the first output voltage VOUT1 is still smaller than the predetermined voltage value, then the first output voltage VOUT1 is sent to the voltage compensation circuit (not shown in FIG. 2) to increase the voltage value of the first output voltage to the predetermined voltage value as the load needs; however, it is not limited thereto.

Briefly, in the instant disclosure, when the first input voltage VIN1 of the bias circuit 200 is close to or equal to the zero level voltage, the bias circuit 200 is not going to perform charging to the charging battery 140 via the charging management circuit 210; instead, the second input voltage VIN2 supplied from the charging battery 214 is sent to the input terminal of the bias circuit 200 to generate the first output voltage VOUT1.

Based on the above, according to the status of the first input voltage VIN1, it is able to choose a mechanism in the present embodiment to supply the first output voltage VOUT1 to the load or a next-stage circuit with less power consuming. In other words, the bias circuit 200 provided by the present embodiment is able to reduce the wastage of the power and brings out the highest efficiency.

To present more details in describing the operation process of the bias circuit 200 of the instant disclosure, there are further instructions in at least one of the following embodiments.

In the following embodiments, there are only the parts which are different from the embodiment of the FIG. 2 are described; in other words, the omitted parts are the same as described in the first embodiment. In addition, for the convenience during the instruction, similar numbers or codes refer to similar elements.

### Another Alternate Embodiment of a Bias Circuit

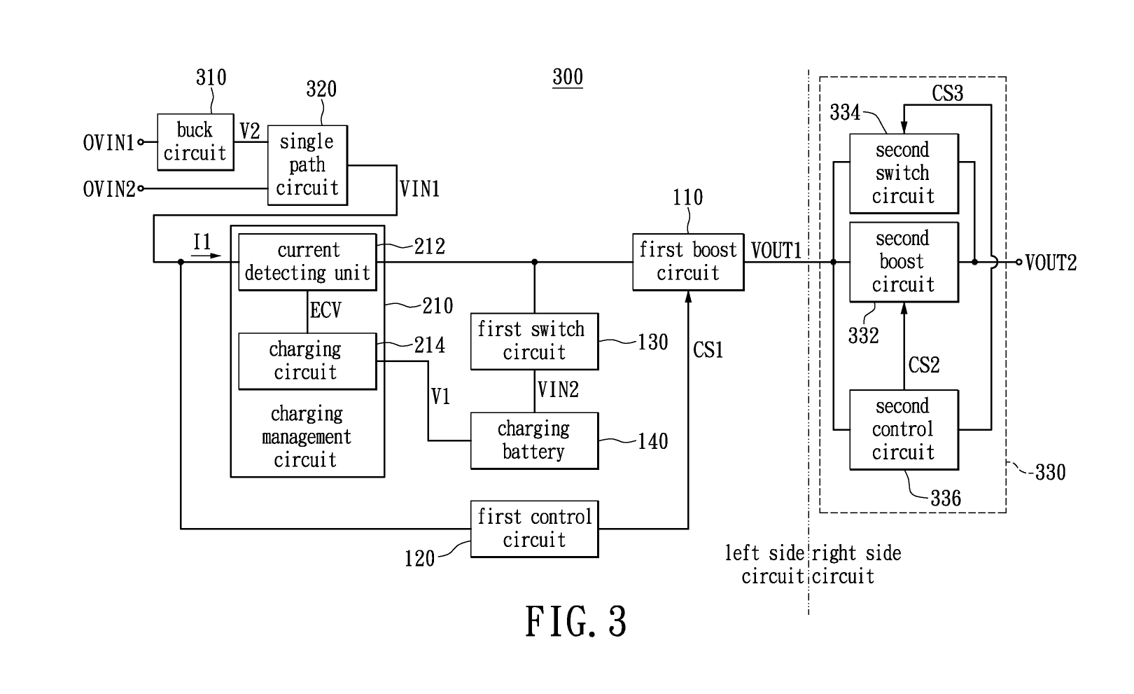

Referring to FIG. 3, FIG. 3 shows a circuit diagram of a bias circuit according to another alternate embodiment of the instant disclosure. Different from the embodiment of the FIG. 2, in the present embodiment, the bias circuit 300 further includes a buck circuit 310, a single path circuit 320, and a voltage compensation circuit 330. The voltage compensation circuit 330 includes a second boost circuit 332, a second switch circuit 334, and a second control circuit 336.

The single path circuit 320 is electrically connected between the buck circuit 310 and the charging management circuit 210. The voltage compensation circuit 330 is electrically connected to a first boost circuit 110. The second boost circuit 332 is electrically connected to the first boost circuit 110. The second switch circuit 334 is electrically connected to the second boost circuit 332 in parallel. The second control circuit 336 is electrically connected to the second boost circuit 332 and the second switch circuit 334.

The buck circuit 310 receives a first original input voltage OVIN1. The single path circuit 320 receives a second original input voltage OVIN2 and outputs a first input voltage VIN1, wherein the voltage value of the first original input voltage OVIN1 is larger than a predetermined voltage value, and the voltage value of the second original input voltage OVIN2 is equal to the predetermined voltage value. In the present embodiment, the voltage value of the first original input voltage OVIN1 is 12 volts, and the voltage value of the second original input voltage OVIN2 is 5 volts, wherein the first original input voltage OVIN1 and the second original input voltage OVIN2 are supplied by one power socket, and the power socket is a Micro USB. In another embodiment, the power socket offers pins of different specifications of input voltage, wherein any of the pin voltage larger than the predetermined voltage value is needed to be electrically connected to the buck circuit 310 to reduce to the predetermined voltage value, but it is not limited to be 5 volts or 12 volts as in the present embodiment.

The voltage compensation circuit 330 is used to compensate the first output voltage VOUT1 to the predetermined voltage value. The second boost circuit 332 is used to receive the first output voltage VOUT1, and to output a second output voltage VOUT2. The second switch circuit 334 determines whether to be set as an open or closed status according to a third control signal CS3 received. The second control circuit 336 receives the first output voltage VOUT1 and accordingly transmits the second control signal CS2 and the third control signal CS3 to the corresponding second boost circuit 332 and the second switch circuit 334 respectively. When the first output voltage VOUT1 is equal to the predetermined voltage value, the second switch circuit 334 is open and the second boost circuit 332 is disabled, wherein the second output voltage VOUT2 is equal to the predetermined voltage value of the first output voltage VOUT1.

It is worth mentioning that in an embodiment (for example, a combination of a cradle and a Tablet PC), the left side circuit is a bias circuit 300 of the bias circuits of the cradles for the similar types of the electronic products, and the right side circuit is a voltage compensation circuit 300 of the cradles for the similar types of the electronic products for a use of detecting if the voltage value of the first output voltage VOUT1 reaches a predetermined voltage value. If the voltage value of the first output voltage VOUT1 not reaches a predetermined voltage value, the voltage compensation circuit 330 increases the first output voltage VOUT1 to the predetermined voltage value and outputs a second output voltage VOUT2.

The following paragraphs further describe the detailed operation of the bias circuit 300. However, it is noticed that the purpose of an example of a power socket supplying power for two input voltage in the following embodiment is to explain the instant disclosure more clearly; which means, the first original input voltage OVIN1 and the second original input voltage OVIN2 are not used to limit the instant disclosure in any way.

Referring to FIG. 3, after a power socket or the Micro USB (not shown in FIG. 3) receiving a source voltage (such as a city power of 120 volts), and accordingly the power socket or the Micro USB supplies the first original input voltage OVIN1 and the second original input voltage OVIN 2, wherein, in the present embodiment, the first original input voltage OVIN1 is equal to 12 volts, and the second original input voltage OVIN2 is equal to 5 volts, wherein the 5 volts is set as the predetermined voltage value, and the predetermined voltage value is set according to the designer based on an actual demand of product design, and is not limited thereto. The buck circuit 310 reduces the second original input voltage OVIN2 received to the second voltage V2, wherein the voltage value of the second voltage V2 is the predetermined voltage value (i.e. 5 volts). After the single path circuit 320 receives the second voltage V2 or the second original input voltage OVIN2 (i.e. 5 volts), the single path circuit 320 outputs the first input voltage VIN1 to the charging management circuit 210, wherein the single path circuit 320 is used to avoid the output first input voltage VIN1 from affecting the voltage values of the first original input voltage OVIN1 and the second original input voltage OVIN2. It is worth noticing that the voltage value of the first input voltage VIN1 is the predetermined voltage value (i.e. 5 volts) at the time.

Next, when the charging management circuit 210 is electrically connected to the first input voltage VIN1 which is equal to the predetermined voltage value (such as 5 volts), the first control circuit 120 detects the first input voltage VIN1 (equal to the predetermined voltage value) and the first control circuit 120 transmits the first control signal CS1 to the first boost circuit 110 to disable the first boost circuit 110 according to the first input voltage VIN1. In the meantime, the current detecting unit 212 receives the first input current I1, and the current detecting unit 212 transmits the charging enable voltage ECV to the charging circuit 214 according to the detected first input current I1, and the charging circuit 214 transmits the first voltage V1 corresponding to the first current I1 to the charging battery 140 to perform charging according to the charging enable voltage ECV received. In addition, the first switch circuit 130 is closed since the first input voltage VIN1 is equal to the predetermined voltage value (5 volts); furthermore, although the output terminal of the current detecting unit 212 consumes part of the power supplied by the first input voltage VIN1, the output terminal of the current detecting unit 212 outputs a voltage which is slightly smaller than the predetermined voltage value, in the present embodiment, the voltage is enough to close the first switch circuit 130. For the convenience in instruction, it is assumed that both the input and output terminals of the current detecting unit 212 are the first input voltage VIN1. Based on the assumption, the charging battery 140 is not able to output the second input voltage VIN2 to the input terminal of the first boost circuit 110 via the first switch 130.

Next, the first boost circuit 110 converts the first input voltage VIN1 received into the first output voltage VOUT1, and the first boost circuit 110 sends the first output voltage VOUT1 to the voltage compensation circuit 330 to determine whether to perform a voltage compensation or not. In an embodiment, the first boost circuit 110 is in the disabled status, and the first boost circuit 110 is equipped with electronic elements inside, there is some part of power consumed on energy-consuming elements inside the first boost circuit 110. Then, when the first output voltage VOUT1 is smaller than the predetermined voltage value, the second control circuit 336 transmits the second control signal CS2 and the third control signal CS3 to the corresponding second boost circuit 332 and the second switch circuit 334 respectively according to the detected first output voltage VOUT1. Afterwards, the second boost circuit 332 is enabled according to the second control signal CS2 and the second switch circuit 334 is closed according to the third control signal CS3 received. Therefore, the second boost circuit 332 increases the first output voltage VOUT1 received to the predetermined voltage value and outputs the second output voltage VOUT2, wherein the voltage value of the second output voltage VOUT2 is equal to the predetermined voltage value.

In an alternate embodiment, when the first output voltage VOUT1 is equal to the predetermined voltage value, the second control circuit 336 transmits the second control signal CS2 and the third control signal CS3 to the corresponding second boost circuit 332 and the second switch circuit 334 respectively according to the d first output voltage VOUT1 detected, and afterwards, the second boost circuit 332 is disabled according to the second control signal CS2 received and the second switch circuit 334 is open according to the second control signal CS3 received. Then, the second switch circuit 334 transmits the first output voltage VOUT1 received which is equal to the predetermined voltage value to the output terminal of the bias circuit 300; which means, the second switch circuit 334 outputs a second output voltage VOUT2, wherein the voltage value of the second output voltage VOUT2 is equal to the predetermined voltage value.

Briefly, in the instant disclosure, when the bias circuit 300 receives the first input voltage VIN1 which is equal to the predetermined voltage value, the bias circuit 300 is going to perform charging to the charging battery 140 via the charging management circuit 210, and the bias circuit 300 then transmits the first input voltage VIN1, which has sacrificed some of the power, to the input terminal to generate the first output voltage VOUT1. Then, the bias circuit 300 uses the voltage compensation circuit 330 to perform a voltage compensation on the second output voltage VOUT2 to increase the second output voltage VOUT2 to the predetermined voltage value; which means, the bias circuit 300 is able to supply the second output voltage VOUT2 of 5 volts to a load or to the next-stage circuit (not shown in FIG. 3).

On the other hand, when the power socket or the Micro USB (not illustrated in FIG. 3) is not connected to a source voltage (such as a building voltage), the power socket or the Micro USB is not able to supply the first original input voltage OVIN1 of 12 volts and the second original input voltage OVIN2 of 5 volts. In other words, a pin voltage of the power socket is in a floating state, and therefore the first input voltage VIN1 is in the floating state as well. In an embodiment, the first input voltage VIN1 is close to or equal to the zero level voltage. Then, the first control circuit 120 detects the first input voltage VIN1 (not equal to the predetermined voltage value) and the first control circuit 120 transmits a first control signal CS1 to the first boost circuit 110 to enable the first boost circuit 110 according to the first input voltage VIN1 detected. In the meantime, the current detecting unit 212 detects the first input current I1 (the voltage value of the first current I1 is zero at the time), and the current detecting unit 212 transmits the charging enable voltage ECV corresponding to the first current I1 to the charging circuit 214 according to the first input current I1 detected, and the charging circuit 214 transmits the first voltage V1 corresponding to the first current I1 to the charging battery 140 to perform charging according to the charging enable voltage ECV received. It is noticed that under the circumstances, the charging circuit 214 is not going to perform charging to the charging battery 140. Furthermore, the first switch circuit 130 is open because the first input voltage VIN1 is close to or equal to the zero level voltage (0 volts); therefore, the charging battery 140 then outputs an second input voltage VIN2 to the input terminal of the first boost circuit 110 via the first switch circuit 130. Next, the first boost circuit 110 converts the second input voltage VIN2 received into the first output voltage VOUT1, wherein the voltage value of the second input voltage VIN2 is smaller than the predetermined voltage value. Since the first boost circuit 110 is in the enabled status, the first boost circuit 110 increases the second input voltage VIN2 to be equal to the predetermined voltage value and outputs the first output voltage VOUT1 to the voltage compensation circuit 330 to determine whether to perform a voltage compensation.

In an embodiment, when the first output voltage VOUT1 is smaller than the predetermined voltage value, the second control circuit 336 sends the second control signal CS2 and the third control signal CS3 to the corresponding second boost circuit 332 and the second switch circuit 334 respectively according to the first output voltage VOUT1 detected. Afterwards, the second boost circuit 332 is enabled according to the second control signal CS2 and the second switch circuit 334 is closed according to the third control signal CS3 received. Therefore, the second boost circuit 332 increases the first output voltage VOUT1 received to the predetermined voltage value and outputs the second output voltage VOUT2, wherein the voltage value of the second output voltage VOUT2 is equal to the predetermined voltage value.

In an alternate embodiment, when the first output voltage VOUT1 is equal to the predetermined voltage value, the second control circuit 336 transmits the second control signal CS2 and the third control signal CS3 to the corresponding second boost circuit 332 and the second switch circuit 334 respectively according to the first output voltage VOUT1 detected, and afterwards, the second boost circuit 332 is disabled according to the second control signal CS2 received and the second switch circuit 334 is open according to the second control signal CS3 received. Then, the second switch circuit 334 sends the first output voltage VOUT1 received which is equal to the predetermined voltage value to the output terminal of the bias circuit 300; which means, the second switch circuit 334 outputs a second output voltage VOUT2, wherein the voltage value of the second output voltage VOUT2 is equal to the predetermined voltage value.

Briefly, in the instant disclosure, when the first input voltage VIN1 of the bias circuit 300 is close to or equal to the zero level voltage, the bias circuit 300 is not going to perform charging to the charging battery 140 via the charging management circuit 210; instead, the second input voltage VIN2 supplied from the charging battery 214 is sent to the input terminal of the bias circuit 200 to generate the first output voltage VOUT1. Then, the bias circuit 300 uses the voltage compensation circuit 330 to perform a voltage compensation on the second output voltage VOUT2 to increase the second output voltage VOUT2 to be equal to the predetermined voltage value; which means, the bias circuit 300 is able to supply the second output voltage VOUT2 of 5 volts to the load or to the next circuit (not shown in FIG. 3).

Based on the above, in the present embodiment, it is not only able to base on the status of the first input voltage VIN1 to choose a mechanism to supply the first output voltage VOUT1 with less power consuming, but is also able to detect and compensate the first output voltage VOUT1 to make sure the second output voltage VOUT2 to be equal to the predetermined voltage value.

To present more details in describing the operation process of the bias circuit of the instant disclosure, there are further instructions in at least one of the following embodiments.

In the following embodiments, there are only the parts which are different from the embodiment in FIG. 3 are described; in other words, the omitted parts are the same as described in the embodiment in FIG. 3. In addition, for the convenience during the instruction, similar numbers or codes refer to similar elements.

### Another Alternate Embodiment of a Bias Circuit

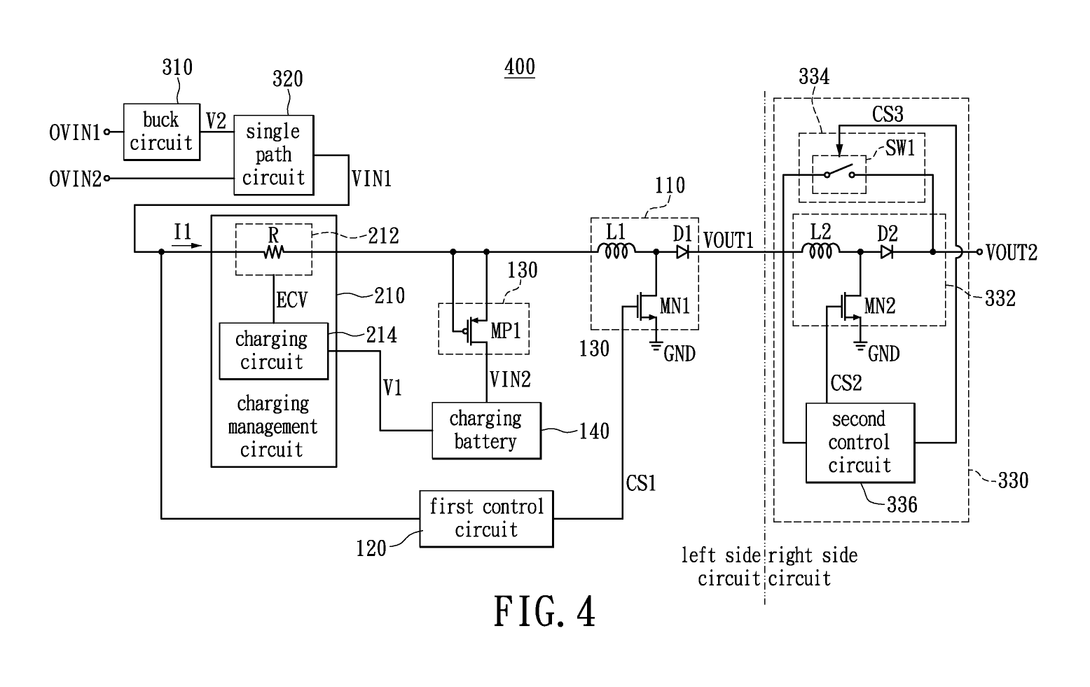

Referring to FIG. 4, FIG. 4 shows a detailed diagram of a bias circuit according to an embodiment of the instant disclosure. In the present embodiment, different from the embodiments in FIGS. 1 and 2, a current detecting unit 210 includes a resistor R. A first switch circuit 130 includes a first P-type transistor MP1. A first boost circuit 110 includes a first inductance L1, a first N-type transistor MN1 and a first diode D1. A second switch circuit 334 includes a first switch SW1. A second boost circuit 332 includes a second inductance L2, a second N-type transistor MN2, and a second diode D2.

A first terminal of the resistor R is electrically connected to a first input voltage VIN, and a second terminal of the resistor R is electrically connected to an input terminal of a first boost circuit 110. A source and a gate of the first P-type transistor MP1 are electrically connected to the input terminal of the first boost circuit 110, and a drain of the first P-type transistor MP1 is electrically connected to a charging battery 140. The first terminal of the first inductance L1 is electrically connected to the source and the gate of the first P-type transistor MP1. A drain of the N-type transistor MN1 is electrically connected to a second terminal of the first inductance L1, and a gate of the first N-type transistor MN1 receives a first control signal CS1, and a source of the first N-type transistor MN1 is electrically connected to a ground voltage GND. A anode of the first diode D1 is electrically connected to the second terminal of the first inductance L1, and a cathode of the first diode D1 outputs a first output voltage VOUT1. The first terminal of the first switch SW1 receives the first output voltage VOUT1, and the second terminal of the first switch SW1 outputs a second output voltage VOUT2. The first terminal of the second inductance L2 is electrically connected to the first output voltage VOUT1. The drain of the second N-type transistor MN2 is electrically connected to the second terminal of the second inductance L2, and the gate of the second N-type transistor MN2 receives a second control signal CS2, and the source of the second N-type transistor MN2 is electrically connected to the ground voltage GND. A cathode of the second diode D2 is electrically connected to the second terminal of the second inductance L2, and a cathode of the second diode D2 outputs the second output voltage VOUT2.

The following paragraphs further teach the detailed operation of the bias circuit 400. Referring to FIG. 4, in the present embodiment, after a power socket or the Micro USB (not illustrated in FIG. 4) receiving a source voltage (such as an building electricity of 120 volts), and accordingly the power socket or the Micro USB supplies a first original input voltage OVIN1 and a second original input voltage OVIN2, wherein, in the present embodiment, the first original input voltage OVIN1 is equal to 12 volts, and the second original input voltage OVIN2 is equal to 5 volts, wherein the 5 volts is set as the predetermined voltage value. Then, the buck circuit 310 reduces the second original input voltage OVIN2 received to the second voltage V2, wherein the voltage value of the second voltage V2 is the predetermined voltage value (i.e. 5 volts). After the single path circuit 320 receives the second voltage V2 or the second original input voltage OVIN2 (i.e. 5 volts), the single path circuit 320 outputs the first input voltage VIN1 to the charging management circuit 210, wherein the single path circuit 320 is used to avoid the output first input voltage VIN1 from affecting the voltage values of the first original input voltage OVIN1 and the second original input voltage OVIN2. It is worth noticing that the voltage value of the first input voltage VIN1 is the predetermined voltage value (i.e. 5 volts) at the time.

Next, when the charging management circuit 210 is electrically connected to the first input voltage VIN1 which is equal to the predetermined voltage value (such as 5 volts), the first control circuit 120 detects the first input voltage VIN1 (equal to the predetermined voltage value) and accordingly transmits the first control signal CS1 to the gate of the first N-type transistor MN1 to switch off the N-type transistor MN1; that is to disable the first boost circuit 110, wherein the first control signal CS1 is a low level voltage. In the meantime, the resistor R of the charging management circuit 210 receives the first input current I1, and according to Ohm's Law, the resistor R generates a charging enable voltage ECV according to the first input current I1 detected, and transmits the charging enable voltage ECV to the charging circuit 214. Then, according to the charging enable voltage ECV received, the charging circuit 214 transmits the first voltage V1 corresponding to the first current I1 to the charging battery 140 to perform charging. Furthermore, as a switch, the first P-type transistor MP1 is switched off because the first input voltage VIN1 is equal to or close to the predetermined voltage (i.e. 5 volts). To be more specific, the resistor R consumes a part of power from the first input voltage VIN1, but the second terminal (the output terminal) of the resistor R outputs a voltage which is slightly smaller than the predetermined voltage value, and in the present embodiment, the voltage is enough to switch off the first P-type transistor MP1 inside the first switch circuit 130. For the convenience in instruction, it is assumed that both the first and second terminals of the resistor R are the first input voltage VIN1. Based on the assumption, the charging battery 140 is not able to output the second input voltage VIN2 to the input terminal of the first boost circuit 110 via the first P-type transistor MP1.

Then, since the first N-type transistor MN1 is in the closed status, the first boost circuit is in the disabled status as well. The first boost circuit 110 converts the first input voltage VIN1 received into the first output voltage VOUT1, and the first boost circuit 110 transmits the first output voltage VOUT1 to the voltage compensation circuit 330 to determine whether to perform a voltage compensation. In an embodiment, since the first boost circuit 110 is in the disabled status and there are the first inductance L1 and the first diode D1 inside the first boost circuit 130, which causes part of the power from the first input voltage VIN1 is consumed because of the elements inside the first boost circuit 110.

When the first output voltage VOUT1 is smaller than the predetermined voltage value, the second control circuit 336 transmits the second control signal CS2 and the third control signal CS3 to the corresponding gate of the second N-type transistor MN2 and the first switch SW1 respectively according to the first output voltage VOUT1 detected. Afterwards, the first switch SW1 is switched off according to the third control signal CS3 received. Therefore, according to the first output voltage VOUT1, the second boost circuit 332 increases the first output voltage VOUT1 to the predetermined voltage value and outputs the second output voltage VOUT2, wherein the voltage value of the second output voltage VOUT2 is equal to the predetermined voltage value.

In an alternate embodiment, when the first output voltage VOUT1 is equal to the predetermined voltage value, the second control circuit 336 transmits the second control signal CS2 and the third control signal CS3 to the corresponding gate of the second N-type transistor MN2 and the first switch SW1; afterwards, the second boost circuit 332 is disabled according to the second control signal CS2 received and the second switch circuit 334 is open according to the second control signal CS3 received. Then, the first switch SW1 transmits the first output voltage VOUT1 received which is equal to the predetermined voltage value to the output terminal of the bias circuit 400; which means, the second switch circuit 334 outputs a second output voltage VOUT2, wherein the voltage value of the second output voltage VOUT2 is equal to the predetermined voltage value.

On the other side, when the power socket or the Micro USB (not illustrated in FIG. 4) is not connected to a source voltage (such as a building voltage), the power socket or the Micro USB is not going to supply a first original input voltage OVIN1 of 12 volts and a second original input voltage OVIN2 of 5 volts. In other words, a pin voltage of the power socket is in a floating state, and therefore the first input voltage VIN1 is in the floating state as well. In an embodiment, the first input voltage VIN1 is close to or equal to the zero level voltage.

Then, the first control circuit 120 detects the first input voltage VIN1 (not equal to the predetermined voltage value) and the first control circuit 120 transmits a first control signal CS1 to the gate of the first N-type transistor MN1 to switch on the first N-type transistor MN1 according to an first input voltage VIN1 detected; which is to enable the first boost circuit 110, wherein the first control signal CS1 is a high level voltage. In the meantime, the resistor R of the charging management circuit 210 receives the first input current I1 whose voltage value is zero amperes, and according to Ohm's Law, the resistor R generates a charging enable voltage ECV which is zero volts, and transmits the charging enable voltage ECV to the charging circuit 214. Then, according to the charging enable voltage ECV received, the charging circuit 214 transmits the first voltage V1 corresponding to the charging enable voltage ECV to the charging battery 140. It is worth mentioning that, under the circumstances, the charging circuit 214 is not going to perform charging to the charging battery 140. Furthermore, as the switch, the first P-type transistor MP1 is switched on because the first input voltage VIN1 is equal to or close to the zero level voltage; therefore, via the first P-type transistor MP1, the charging battery 140 outputs the second input voltage VIN2 to the input terminal of the first boost circuit 110. Then, the first boost circuit 110 converts the second input voltage VIN2 received into the first output voltage VOUT1, wherein the voltage value of the second input voltage VIN2 is smaller than the predetermined voltage value. Since the first N-type transistor MN1 is in the switched on status, the first boost circuit 110 increases the second input voltage VIN2 to the predetermined voltage value and outputs the first output voltage VOUT1 to the voltage compensation circuit 330 to determine whether to perform the voltage compensation.

When the first output voltage VOUT1 is smaller than the predetermined voltage value, the second control circuit 336 transmits the second control signal CS2 and the third control signal CS3 to the corresponding gate of the second N-type transistor MN2 and the first switch SW1 respectively according to the first output voltage VOUT1 detected. Afterwards, the first switch SW1 is switched on according to the third control signal CS2 received; which means the second boost circuit 332 is in the enabled status, and the first switch SW1 is switched off according to the third control signal CS3 received. Therefore, the second boost circuit 332 increases the first output voltage VOUT1 received to the predetermined voltage value and outputs the second output voltage VOUT2, wherein the voltage value of the second output voltage VOUT2 is equal to the predetermined voltage value.

In an alternate embodiment, when the first output voltage VOUT1 is equal to the predetermined voltage value, according to the first output voltage VOUT1 detected, the second control circuit 336 transmits the second control signal CS2 and the third control signal CS3 to the corresponding gate of the second N-type transistor MN2 and the first switch SW1; afterwards, the second boost circuit 332 is disabled according to the second control signal CS2 received and the second switch circuit 334 is open according to the third control signal CS3 received. Then, the first switch SW1 transmits the first output voltage VOUT1 received which is equal to the predetermined voltage value to the output terminal of the bias circuit 400; which means, the second switch circuit 334 outputs the second output voltage VOUT2, wherein the voltage value of the second output voltage VOUT2 is equal to the predetermined voltage value.

### Embodiment of an Electronic Device

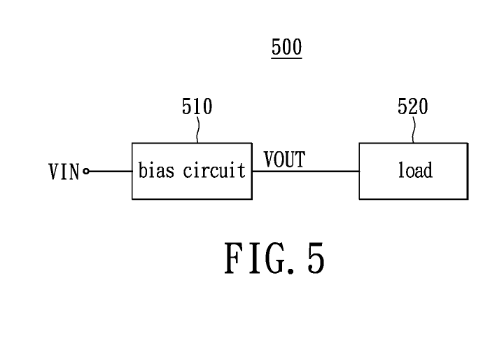

Referring to FIG. 5, FIG. 5 shows a schematic diagram of an electronic device according to an embodiment of the instant disclosure. The electronic device includes a load 520 and a bias circuit 510 which is electrically connected to the load 520, wherein the bias circuit 510 receives an input voltage VIN. The bias circuit 510 may be one of the bias circuits 100, 200, 300, 400 in the above recited embodiments, and is used to supply an output voltage VOUT to the load 520 stably. The electronic device 500 may be any type of electronic device, such as a Tablet PC.

To sum up, an embodiment of the instant disclosure provides a bias circuit and an electronic device, and allows the input voltage to be sent to the output terminal of the bias circuit with little sacrifice of power via the route of the resistor and the first boost circuit, and a first output voltage is supplied. In other words, in the present embodiment, without making the input voltage to take the route of the charging management circuit and the charging battery, the wastage of power is reduced and the highest efficiency is achieved.

In at least one of the embodiments of the instant disclosure, the bias circuit further offers a voltage compensation circuit consisted of a second boost circuit, a second switch circuit, and a second control circuit. Therefore, in an alternate embodiment of the instant disclosure, it is possible to detect and compensate the first output voltage, and to make sure the second output voltage is actually equal to or more closer to a predetermined voltage value.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A bias circuit, comprising:
a first boost circuit, receiving a first control signal and determining whether to be enabled according to the first control signal;
a first control circuit, electrically connected to the first boost circuit, and the first control circuit transmits the first control signal according to a first input voltage detected; and
a first switch circuit, electrically connected between the first boost circuit and a charging battery, and the first switch circuit determines to be open or closed according to the first input voltage;
wherein when the first input voltage is equal to a predetermined voltage value, the first switch circuit is closed and the first boost circuit controlled by the first control signal is disabled, and the first boost circuit converts the first input voltage into a first output voltage, wherein the first output voltage is smaller than the predetermined voltage value.

2. The bias circuit according to claim 1, wherein when the first input voltage is close to a zero level voltage, the first switch circuit is open and the first boost circuit controlled by the first control signal is enabled, and the first boost circuit increases a second input voltage sent by the charging battery via the first switch circuit to the first output voltage, wherein the first output voltage is equal to the predetermined voltage value.

3. The bias circuit according to claim 1, further comprising:
A charging management circuit, electrically connected to the first input voltage, the charging battery, and the first boost circuit, the charging management circuit is used to determine whether to transmit the first voltage to the charging battery according to a first input current, wherein the charging management comprising:
a current detecting unit, used to detect and output a charging enable voltage according to the first input current; and
a charging circuit, electrically connected between the current detecting unit and the charging battery, and when the current detecting unit detects the first input current, the charging circuit transmits the first voltage to the charging battery to perform charging according to the charging enable voltage received.

4. The bias circuit according to claim 1, further comprising:
a buck circuit, receiving a first original input voltage and reducing the first original input voltage to the predetermined voltage value as a second voltage; and
a single path circuit, electrically connected to the buck circuit, and the single path circuit receives a second original input voltage and the second voltage, and then outputs the first input voltage,
wherein, the voltage value of the first original input voltage is larger than the predetermined voltage value, and the voltage value of the second original input voltage is equal to the predetermined voltage value.

5. The bias circuit according to claim 1, wherein the first switch circuit comprising:
a first P-type transistor, a source and a gate of which are electrically connected to an input terminal of the first boost circuit, and a drain of the first P-type transistor is electrically connected to the charging battery, wherein when the first input voltage is equal to the predetermined voltage value, the first P-type transistor is switched off; when the first input voltage is close to the zero level voltage, the first P-type transistor is switched on.

6. The bias circuit according to claim 3, wherein the current detecting unit comprising:
a resistor, a first terminal of which is electrically connected to the first input voltage, and a second terminal of the resistor is electrically connected to the input terminal of the first boost circuit, and the resistor is used to detect the first input current and to generate the charging enable voltage.

7. The bias circuit according to claim 5, wherein the first boost circuit comprising:
a first inductance, a first terminal of which is electrically connected to the source and the gate of the first P-type transistor;
a first N-type transistor, a drain of which is electrically connected to a second terminal of the first inductance, and a gate of the first N-type transistor receives the first control signal, and a source of the first N-type transistor is electrically connected to a ground voltage, and
a first diode, a anode of which is electrically connected to the second terminal of the first inductance, and a cathode of the first diode outputs the first output voltage,
wherein when the first input voltage is equal to the predetermined voltage value, the first control circuit transmits the first control signal to the gate of the first N-type transistor to switch off the first N-type transistor, and the first output voltage is smaller than the predetermined voltage value; when the first input voltage is close to a zero level voltage, the first control circuit transmits the first control signal to the gate of the first N-type transistor to switch on the first N-type transistor.

8. A bias circuit, comprising:
a bias circuit according to claim 1; and
a voltage compensation circuit, used to compensate the first output voltage to the predetermined voltage value, wherein the voltage compensation circuit comprising:
a second boost circuit, electrically connected to the first boost circuit, and the second boost circuit outputs a second output voltage;
a second switch circuit, electrically connected to the second boost circuit in parallel; and
a second control circuit, receiving a first output voltage and accordingly transmitting the second control signal and the third control signal to the corresponding second boost circuit and second switch circuit respectively,
wherein when the first output voltage is equal to the predetermined voltage value, the second switch circuit is open and the second boost circuit is disabled, and the second output voltage is equal to the first output voltage.

9. The bias circuit according to claim 8, wherein when the first output voltage is smaller than the predetermined voltage value, the second switch circuit is closed and the second boost circuit is enabled, and the second boost circuit increases the first output voltage to the predetermined voltage value.

10. The bias circuit according to claim 8, wherein the second switch circuit comprising:
a first switch, a first terminal of which receiving the first output voltage, and a second terminal of the first switch outputting a second output voltage, for a use of determining whether to be open according to a third control signal.

11. The bias circuit according to claim 8, wherein the second boost circuit comprising:
a second inductance, a first terminal of which electrically connected to the first output voltage;
a second N-type transistor, a drain of which electrically connected to a second terminal of the second inductance, and the gate of the second N-type transistor receiving the second control signal, and the source of the first N-type transistor electrically connected to a ground voltage; and
a second diode, a anode of which electrically connected to the second terminal of the second inductance, and a cathode of the second diode outputting the second output voltage,
wherein when the first output voltage is equal to the predetermined voltage value, the second control circuit transmits the second control signal to the gate of the second N-type transistor to switch off the second N-type transistor; when the first output voltage is smaller than the predetermined voltage value, the second control circuit transmits the second control signal to the gate of the second N-type transistor to switch on the first N-type transistor, and the first output voltage is increased to be equal to the predetermined voltage value.

12. The electronic device, comprising:
a bias circuit according to claim 1, for a use of outputting the first output voltage or the second output voltage accordingly, wherein the voltage value of the second output voltage is equal to the predetermined voltage value; and
a load, receiving the first output voltage or the second output voltage correspondingly.
